(19) United States
(12) Patent Application Publication
(10) Pub. No.: US 2008/0069560 A1
(43) Pub. Date: Mar. 20, 2008

(54) Monitoring wavelength and power in an optical communications signal

(76) Inventors: Yann Tissot, Lausanne (CH); Marc Epitaux, Sunnyvale, CA (US); Hans Georg Limberger, Lausanne (CH); Rene-Paul Salathe, Ecublens (CH)

Correspondence Address: INTEL/BLAKELY, 1279 OAKMEAD PARKWAY, SUNNYVALE, CA, 94085-4040, US

(21) Appl. No.: 11/521,984

(22) Filed: Sep. 15, 2006

(51) Int. Cl. H04B 10/08

(52) U.S. Cl. 398/25

(57) ABSTRACT

A first out-coupled light spot is produced on a first detector surface, from a first region of varying refractive index formed in an optical waveguide. A second out-coupled light spot is produced on a second detector surface different than the first, from a second region of varying refractive index formed in the waveguide. The light spots are produced in response to a forward propagating communications signal in the waveguide. A signal from the first surface is compared to a signal from the second surface, and this comparison is used to discriminate between a wavelength shift and a change in power in the communication signal. Other embodiments are also described and claimed.

An embodiment of the invention is related to techniques for monitoring wavelength shift and power changes in an optical signal propagating in an optical waveguide. Other embodiments are also described.

### BACKGROUND

There are many reasons for monitoring the wavelength of an optical signal that is propagating in a waveguide. For example, consider the situation where multiple optical channels are transmitted over a single-mode fiber through a process known as wavelength division multiplexing (WDM). In WDM, there are multiple, forward propagating optical signals or channels, each assigned to a different wavelength of light, that have been launched or injected into the fiber at the source or transmitter. Typically, a laser source is used to generate the signal for each channel. Both the power level and the operating wavelength of each signal needs to be within a relatively tight range to ensure a low error rate over a desired reach of the waveguide. As an example, there may be forty channels propagating within a 30 nanometer wavelength band (C-Band). Launching this many different laser wavelengths into an optical fiber calls for precise control and stabilization of the different channel wavelengths.

A laser source can be controlled and stabilized to deliver precise power and wavelength, by a sequential sensing or measurement scheme. In-fiber channel power is sensed and measured, as well as channel wavelength. These have traditionally required separate operations. As an example, an electrical signal from an optical waveguide power tap (or simply, a power tap signal) is produced as a measure of the power of the propagating communications signal. The tap signal can be used to control the transmitter, so as to optimize the injected channel power. A power monitor is a device that senses the power of light launched in an optical fiber regardless of the wavelength of the light.

In a separate operation, the channel wavelength can be measured also using an additional power tap signal. This second power tap signal is highly dependent on the spectral content of the optical signal. Based on the correlation that exists between the power tap signal and the wavelength dependent power tap signal, the channel wavelength can be extracted. A channel monitor is a device that senses the power of a single wavelength channel, within a wavelength band (e.g., C-band).

Fluctuations in the power tap signals may be due to either a wavelength drift of the source, or they may be due to a true optical power drop (e.g., a coupling drop between a laser light source and a fiber core; a drop in injected power, also referred to as channel power drop). A basic, conventional single optical tap mechanism cannot discriminate the causes of a sensed change in the power tap signal. Thus, to determine whether a change in detected optical power has been caused by a wavelength drift, a separate feedback mechanism is needed. In addition, most channel monitors and wavelockers (which are devices that measure wavelength to stabilize the emission wavelength of a laserdiode module at a particular wavelength) operate in an narrow wavelength band. The ability to integrate a wavelocker or channel monitor that has a large wavelength band, in a small package is limited.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows part of an optical wavelength monitor, in accordance with an embodiment of the invention.

FIG. 2 shows the directions of out-coupled light from a pair of gratings.

FIG. 3 illustrates an example transmission spectra for the gratings according to an embodiment of the invention.

FIG. 4 shows an example set of power tap signals that correspond to the transmission spectra in FIG. 3.

FIG. 5 shows example transmission spectra for the gratings in another embodiment of the invention.

FIG. 6 shows a set of power tap signals that correspond to the transmission spectra in FIG. 5.

FIG. 7 shows an optical fiber with a TFBG formed therein.

FIG. 8 illustrates an example transmission spectrum of a TFBG that is Bell-shaped (wavelength dependant).

FIG. 9 shows an example, quasi flat transmission for a TFBG, over a detection wavelength range.

FIG. 10 illustrates the wavelength dependence of P_{TAP} provided by quasi-flat transmission spectrum.

FIG. 11 shows a system application of the power monitor-wavelength monitor, in the form of a data routing device.

### DETAILED DESCRIPTION

According to an embodiment of the invention, an optical tap apparatus is described that may be used to combine wavelength monitoring and power monitoring simultaneously. In one embodiment, a first power tap signal is used alone, for relatively broadband power monitoring. In a second embodiment, a second power tap signal is provided, to enable wavelength selective channel monitoring as well. Such an embodiment enables relatively high-resolution wavelocking, as well as being useful over a relatively broad wavelength band. Certain embodiments are also capable of being placed close to the transmitter. Other embodiments are also described.

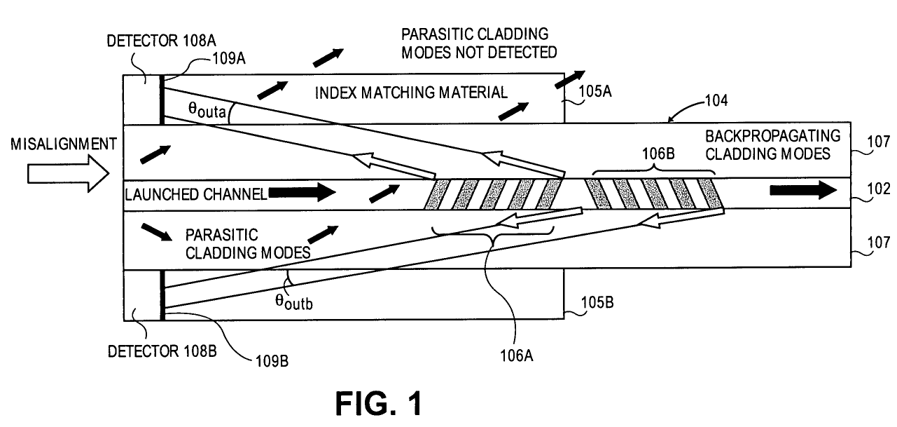

FIG. 1 is a diagram of an optical component 104 which has an optical waveguide 102 in which first and second refractive index gratings 106a, 106b are formed. In this example, the waveguide 102 consists of a single piece of optical fiber, while each grating is a tilted Fiber Bragg Grating (TFBG) formed in the same piece of optical fiber. The concept is also applicable to other types of waveguides such as multi-section waveguides and planar waveguides, with appropriate gratings whose index modulation is not normal to the longitudinal axis of the waveguide. The grating allows the selective coupling of light out of the fiber core and into back propagating cladding modes. Tilting the grating plane may also significantly reduce back reflection in the core, that is inherent to normal fiber Bragg gratings. The launched channel signal may be a time-sliced, multi-wavelength, optical communications signal, or it may be a single wavelength signal.

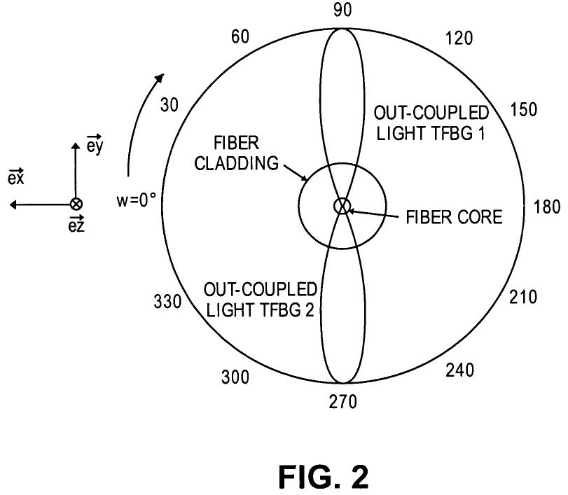

The gratings may be sufficiently closely spaced or they may be entirely superimposed longitudinally to prevent any observed Fabry-Perot effects in the working wavelength band. As an example, the illustration in FIG. 1 depicts the gratings with their axes rotated at an angle of 180 degrees relative to each other, and their positions are not superimposed. The relative azimuthal angle in general is almost arbitrary, so long as light is out-coupled from each grating at different azimuthal angles as shown in FIG. 2, so that no out-coupled light that is intended for one detector overlaps on the other detector.

Referring back to FIG. 1, tapped light is detected by way of a pair of detectors 108a, 108b, each of which has a main incident light surface 109a, 109b that is at an angle of about 90 degrees relative to the longitudinal axis of the waveguide 102 as shown. The surfaces 109a, 109b of the two detectors and the gratings 106a, 106b are oriented relative to each other (about the longitudinal axis) so that out-coupled light from the first and second gratings is detected by the surfaces of the first and second detectors, respectively.

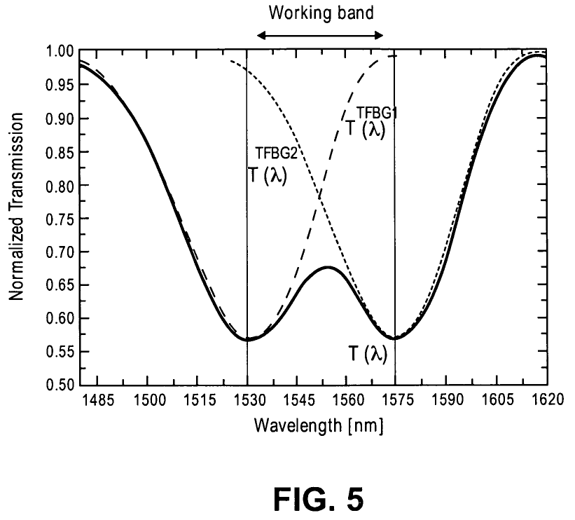

The gratings may be designed to be of different “color”, such as the individual transmission spectra depicted in FIG. 5 by dashed lines. The transmission spectrum of one grating can be shifted relative to the other one, by increasing or decreasing either the grating pitch or the grating tilt. Note also the relatively broad wavelength band of interest in this case, roughly centered around 1550 nanometers.

### First Embodiment

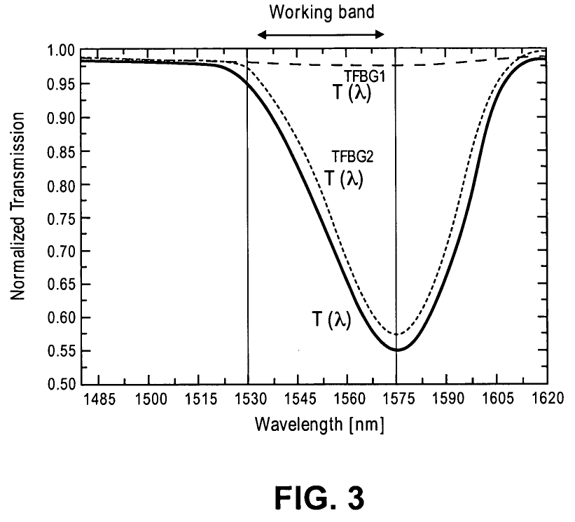

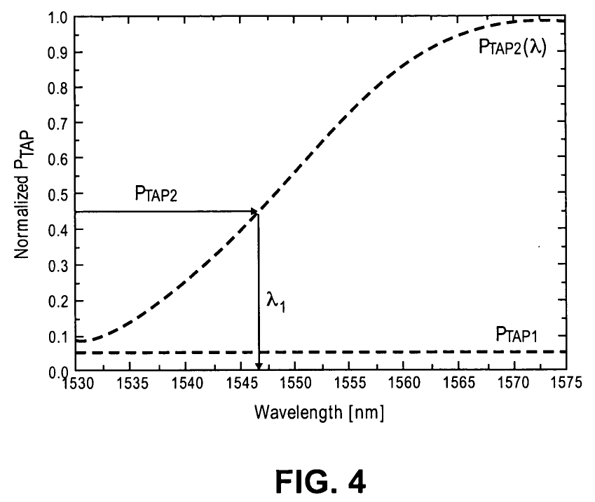

FIG. 4 shows an example set of power tap signals (normalized relative to the launched channel) for the dual grating arrangement of FIGS. 1-2. In this embodiment of the invention, a single power tap signal is used alone for power monitoring (using gratings that have the example transmission spectra depicted in FIG. 3). In this first embodiment, no comparison between the two tap signals is needed for sensing a true power drop. P_{TAP1} is sufficient to detect the true power drop. Once the injected channel power has been optimized using P_{TAP1} to adjust the transmitter, a drop in the second tap signal P_{TAP2} will directly provide the information that a wavelength drift of the transmitter has occurred.

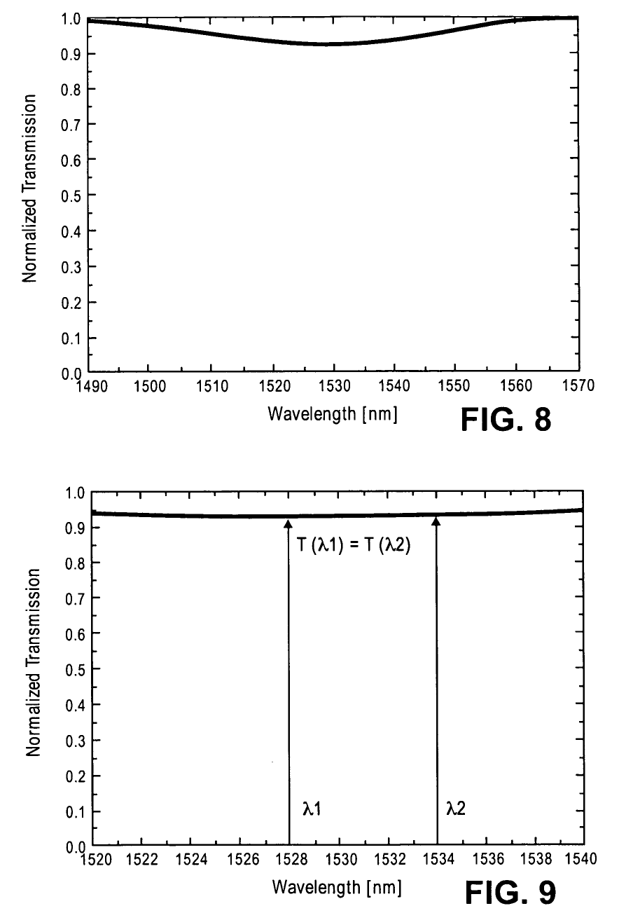

For the first embodiment (FIG. 3 and FIG. 4), the grating parameters of one of the gratings has been adjusted, so as to obtain a quasi-flat P_{TAP} characteristic over the wavelength band of interest (this would be P_{TAP1} in FIG. 4). See the discussion of FIGS. 8 and 9 below for details on how to obtain the quasi flat characteristic. In this way, for example, P_{TAP1} only measures the channel power (independent of wavelength), while the ratio P_{TAP2}/P_{TAP1} is a function of wavelength. Once calibrated, such a device can act as a high resolution wave meter. Referring to FIG. 1, an electrical signal from the first detector surface 109a is compared to a signal from the second detector surface 109b, and this comparison is used to determine both a wavelength shift (e.g., a wavelength drift of the transmitter) and a true power change in the launched channel signal. A “comparison” between two signals may be made using several different techniques, including calculating a ratio of two signal values and using a look-up table. The two detected electrical signals, in this case, P_{TAP1} and P_{TAP2}, are to be compared (by a hardware and/or software system that is not shown), to distinguish wavelength drifts (Δλ), from, for instance, true optical power drops that are either due to a coupling drop Δη or channel power drop ΔPᵢₙ.

### Second Embodiment

In the second embodiment of the invention, both of the optical tap signals are highly wavelength-dependent, over the working wavelength band. The gratings can have the example transmission spectra depicted in FIG. 5. Each grating 106a, 106b is designed in a way that a one-to-one relation exists between the corresponding electrical tap signal P_{TAP} (from its associated detector) and the channel wavelength. In other words, each value of the P_{TAP} signal is associated with a single, different channel. In that case, two channels do not have the same tap value within the working wavelength band, except for a channel that can serve as the calibration wavelength as discussed below. Combining the two tap signals, e.g. using the sum P_{TAP1}+P_{TAP2}, can be a measure of how optimized the injected channel is.

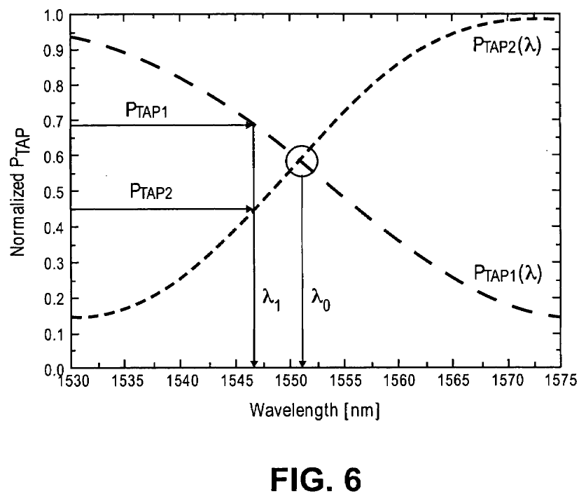

FIGS. 4 and 6 show how the tap signal of a particular detector varies as a function of channel wavelength (in the optical communications signal). In this second embodiment, at any given wavelength of operation, the two tap signal values are different, except for the point where the signals intersect (λ₀=1551 nanometers, in this example). This is also referred to as the calibration wavelength. This intersection point may be used to calibrate the system. As seen in FIG. 6, a positive wavelength drift of the transmitter leads to an increase in P_{TAP2} and simultaneously a decrease in P_{TAP1}.

The behavior of the two P_{TAP} signals can be mapped into digital storage in the system and used to deduce that a wavelength shift has occurred (in response to having detected, for example, a particular change in the ratio P_{TAP1}/P_{TAP2}). The behavior of the two power tap signals also allows deducing absolute wavelength, because each wavelength is associated with a unique combined value.

The optical tap apparatus may be used to distinguish wavelength drifts from true optical power changes. In the second embodiment (FIG. 6), a true power drop is indicated if both P_{TAP1} and P_{TAP2} decrease in amplitude simultaneously. This is in contrast to the case of wavelength drift, which is indicated by P_{TAP1} and P_{TAP2} evolving in opposite directions, that is one is increasing while the other is decreasing simultaneously. Thus, in a case where the channel wavelength of the optical link remains fixed but there is a true power drop (either due primarily to a coupling drop or primarily an injected channel drop), the system would recognize that the relation in FIG. 6 does not apply. Rather, the comparison between the P_{TAP} signals in this case is understood as indicating a true power change, rather than a wavelength drift. In the second embodiment, the system can be calibrated using the intersection wavelength λ₀, to recognize relative changes in true optical power, based on a comparison between the P_{TAP} signals. The second embodiment may also exhibit greater wavelength sensitivity than the first embodiment.

The above-described optical component allows active wavelocking of the transmitter over an entire working band (here approximately 40 nanometers wide) with a resolution that may depend on the signal to noise ratio of the detectors and the temperature dependency of the waveguide material in which the gratings are formed (e.g., for silica, approximately 10 parts per million per degree centigrade).

### Integration with Transmitter

Another aspect of the invention described above is its ability to be integrated with the transmitter, that is positioned close to the channel launching position. This aspect of the invention is further explained here. In a conventional optical fiber tap monitor, light is coupled out of the fiber core and focused onto an array of detectors that are parallel to the axis of the optical fiber. If implemented close to the propagating signal source, this configuration may suffer from cross talk that is due to forward propagating cladding modes that have been generated by misalignment of the communications signal source with the fiber core. Moreover, the focusing unit used in some of these conventional optical taps limits miniaturization of the device. It would therefore be desirable to be free of such shortcomings when placing an optical tap close to the signal source. FIG. 1 shows an optical wavelength monitor, in accordance with an embodiment of the invention, that may be more suitable for miniaturization and integration with the signal source.

In FIG. 1, the optical waveguide 104 is an optical fiber having a core 102 and a cladding 107, with gratings 106a and 106b formed in the core 102. Note the forward propagation direction of the launched channel signal (also referred to as a “core mode”) incident upon the gratings 106a, 106b. The arrow points from an upstream position to a downstream position along the waveguide longitudinal axis. Though not shown, parasitic cladding modes that are propagating in generally the same direction as the launched channel are present. These cannot be completely eliminated at a point upstream of the gratings. Such modes may have been caused by, for example, source misalignment (at a point upstream of the gratings 106a, 106b) or by other aspects that are inherent to free space optics, such as laser beam quality, lens quality, and focusing.

As mentioned above, there are a pair of detectors 108a, 108b each of which has a main incident light surface 109a, 109b that is oriented at about a right angle to the longitudinal or optical axis of the waveguide 104. Each detector may be comprised of one or more photodiodes. In some cases, the use of a multi-quadrant photodiode may allow for better signal to noise ratio. In one embodiment, each surface 109 is sized and positioned to sense the light spot for only one propagating channel or wavelength at a time. The incident light surface 109 is positioned upstream of its respective grating 106 and outside of the waveguide 104 as shown, to receive reflected light (here, back propagating cladding modes out-coupled by index matching material 105) from the grating 106. The position of the detector and its surface 109 may be optimized for sensing a single channel, in accordance with an elevation angle θₒᵤₜ of the reflected and out-coupled light path as shown.

The index matching material 105 fills essentially the entire light path for the reflected light, starting at least from an outside surface of the waveguide (just upstream of the grating) to the detector incident light surface 109. The index matching material 105 should be selected so as to allow the back propagating cladding modes to couple out of the fiber cladding 107 and onto the detector's incident light surface 109. This material may be a gel or a liquid, or, in the embodiment described below, a type of solidified glue or adhesive which also serves to reinforce the fixing of the detector 108 in relation to the waveguide 104. In the embodiment where the optical waveguide comprises an optical fiber including a core 102 and a cladding 107, the index matching material 105 is in contact with the outside surface of the cladding 107 as shown in FIG. 1. Note how the index matching material 105 is also in contact with a substantial portion of the main incident light surface 109 of the detector. Such a continuous region of index matching material avoids the need for any focusing element for the back propagating cladding modes.

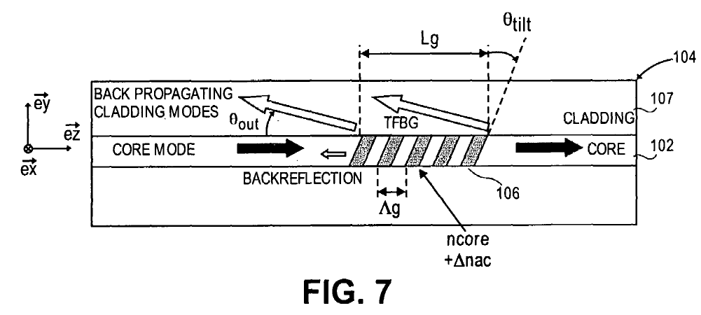

As mentioned above, the forward propagating parasitic cladding modes can severely influence the signal level produced by the detector, if the detector incident light surface were placed parallel to the grating. However, by orienting the detector surface approximately perpendicularly to the fiber axis and upstream of the grating, forward propagating cladding mode cross talk is significantly reduced and more efficient detection is possible for particularly low grating tilt angles θₜᵢₗₜ of less than 20 degrees (see FIG. 7). This yields a versatile optical tap monitor that also has relatively low polarization dependence. Although the monitor can be placed essentially anywhere along the waveguide, it can advantageously be placed relatively close to the channel signal source, thereby allowing miniaturization and integration of a transmitter or transceiver.

Turning now to FIG. 7, details of the operation of a tilted FBG (TFBG), relevant to an optical tap monitor, are shown. The TFBG may be formed using known technology, by taking advantage of the ultraviolet photosensitivity of a fiber core to produce optical filters that have relatively sharp spectral characteristics. The FBG in general is a periodic modulation of the index of refraction in the fiber core. It may be created using the photosensitivity of fiber glass to ultraviolet light (between 150-350 nanometers) or femtosecond laser light (around 800 nanometers, second and third harmonics). An FBG acts as a selective filter since reflection at each plane of modulation act constructively, leading to an efficient back-reflection in the core. A tilted FBG has an index modulation that is not normal to the fiber axis (note the angle shown in FIG. 7 as θₜᵢₗₜ). This leads to the selective coupling of light out of the fiber core into back propagating cladding modes and to reduce the core mode back reflection. The tilt angle θₜᵢₗₜ and the grating pitch Λ_{g} determine the spectral width of the out-coupled light. The magnitude of the induced index modulation (Δn_{ac}), and the length of the grating L_{g}, determine the out-coupling intensity. Light is out-coupled in the longitudinal direction at an angle θₒᵤₜ, and in the azimuthal direction at an angle ψ=90° with respect to the ex axis (as illustrated in FIG. 2), e.g. along the ey axis. Thus, each detector surface should be appropriately positioned both longitudinally and in the azimuthal plane, to receive sufficient reflected light (out-coupled light) from its associated grating, to sense the power of the launched channel in the optical waveguide.

The position of each detector relative to the waveguide may be given by the following relationship for elevation angle θₒᵤₜ:

$$cos {θ}_{out} ( λ ) = \frac{\frac{λ}{{Λ}_{g}} cos ( {θ}_{tilt} ) - {n}_{eff}^{core}}{{n}_{external}}$$

where n^{core} is the effective index of refraction of the waveguide at the grating, and nₑₓₜₑᵣₙₐₗ is the index of refraction of the index matching material. Thus, the detector should be located at a position that provides the desired detected power, according to the elevation angles θₒᵤₜ related to the detected wavelength band (variable λ).

When using a tunable light source to transmit multiple, forward propagating (core mode) channels, the channels may be time sliced. In that case, each channel is out-coupled at a peculiar elevation angle θₒᵤₜ. Therefore, if the detector is sufficiently large for covering the elevation angle range corresponding to the out-coupled wavelength band, then each channel is sensed properly. For example, a wavelength band of more than 40 nm can be sensed with a detector that is about 1 mm wide.

### Grating with Quasi-Flat Transmission

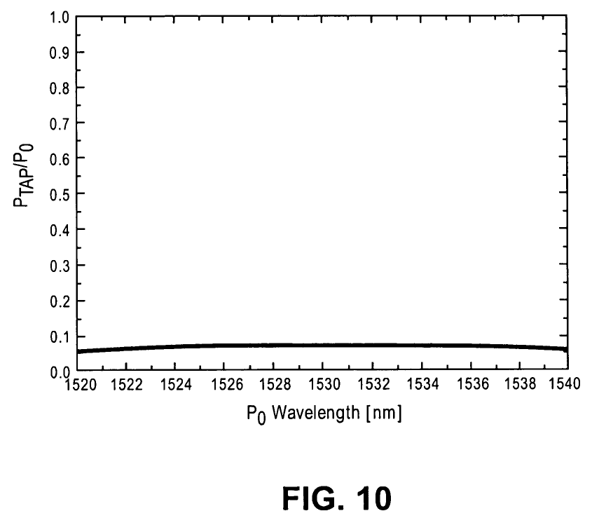

According to the first embodiment of the invention, the tapped light spot or signal that is incident on one of the two detectors (see FIG. 1) is essentially wavelength independent and is linear to the injected signal power. This may be achieved by designing the TFBG (associated with that detector) to have a quasi flat transmission spectrum, over a limited spectral range. This is in contrast to a Bell-like spectrum depicted in FIG. 8. FIG. 9 shows an example, quasi flat transmission over a detection wavelength range. Note how the transmission spectrum has been flattened, that is, the slope of the Bell curve in FIG. 8 has been reduced, to exhibit less than five percent variation over the detected wavelength range. This can be achieved using a combination of different techniques. For instance, the period of the grating L_{g} may be varied, the mean index of refraction within the grating may be varied, or the tilt angle may be varied along the grating or by a superposition of gratings with different parameters. This is referred to as a period, index, or tilt angle chirp. In another technique, the amplitude of the index of refraction that has been induced along the fiber grating is varied. This is referred to as apodization. Chirp and apodization may be combined. Yet another way to obtain a quasi flat transmission spectrum is to induce a low coupling coefficient for the grating. The quasi flat spectrum allows better correlation of the power that has been detected by the detector (P_{TAP}) with the power that has been injected into the waveguide (P₀) as illustrated in the example plot of FIG. 10 which shows P_{TAP} normalized by P₀, i.e. P_{TAP}/P₀, as a function of injected wavelength. Note how the tap signal P_{TAP} is essentially proportional to P₀.

### System Applications

The optical component described above may be used as both a power monitor and a wavelength monitor simultaneously. Certain embodiments of the invention may be calibrated automatically at a calibration wavelength, which is a point of intersection of the two P_{TAP} signals. The wavelength monitoring may operate over a relatively large wavelength band. In addition, the calibrated component can be used to measure absolute wavelength. Also, the insertion loss of the component can advantageously be relatively low, e.g. less than 50% (3 dB), relative to other commercial wavelocking devices that are currently available.

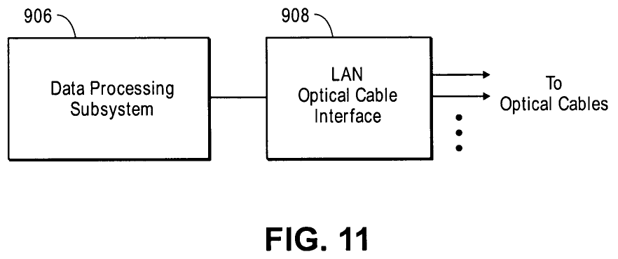

FIG. 11 shows a system application of the power and wavelength monitor described above, in the form of a data routing device. The data routing device may be a switch (e.g., a Wavelength Selective Switch, WSS) or a router that can process and forward data packets. As an alternative, the device may be one that passes time division multiplexed (TDM) signals. The data routing device has a data processing subsystem 906 that may have a CPU and memory that are programmed to process data traffic that is routed by the device. Incoming and outgoing data traffic are via optical cables (not shown) that are connected to a local area network (LAN) optical cable interface 908 of the routing device. The interface 908 is designed for LAN optical cables which may be used in short distance optical links, in contrast to long distance or long-haul optical cables such as those typically used by telecommunication companies and long-haul fiber optic networks. The interface 908 may include discrete optical subassemblies or transceiver packages in which the power-wavelength monitor is integrated. In addition, the interface 908 may also include an integrated, LAN optical cable connector (that mates with one attached to the optical cable). Also, serializer-deserializer circuitry may be provided that serializes packets from the data processing subsystem 906 for transmission, and deserializes a received bit stream from the optical cables into, for example, multiple byte words in the format of the data processing subsystem 906. The data processing subsystem 906 operates on such packets to determine, for example, a destination node to which the packet will be forwarded, using a routing algorithm, for example, and/or a routing table.

The invention is not limited to the specific embodiments described above. For example, although the figures show an embodiment of the invention in the context of an optical fiber, the concepts are also applicable to other types of optical waveguides. Also, the invention is not limited to precisely the angles or positions shown in the figures, as there is a practical tolerance band. For instance, the orientation of the detector surface may be slightly less than 90 degrees, or slightly greater, and still provide the power tap signal with the desired immunity from parasitic forward propagating cladding modes and any associated background noise. Whenever the shapes, relative positions and other aspects of the parts described in the embodiments are not clearly defined, the scope of the invention is not limited only to the parts shown, which are meant merely for the purpose of illustration. Accordingly, other embodiments are within the scope of the claims.

What is claimed is:

1. A method for monitoring wavelength shift and power change in an optical communications signal, comprising:
producing on a first detector surface a first out-coupled light spot from a first region of varying refractive index formed in an optical waveguide, responsive to a forward propagating communications signal in the waveguide;
producing on a second detector surface, different than the first detector surface, a second out-coupled light spot from a second region of varying refractive index formed in the optical waveguide, responsive to the communications signal; and
comparing a signal from the first detector surface to a signal from the second detector surface and using the comparison to discriminate between a wavelength shift and a change in power in the communications signal.

2. The method of claim 1 wherein the communications signal is a time-sliced, multi-wavelength signal.

3. The method of claim 1 wherein the first and second detector surfaces are part of a multi-quadrant photodiode.

4. The method of claim 1 wherein the change in power comprises primarily a coupling drop.

5. The method of claim 1 wherein the change in power comprises primarily a laser power drop.

6. The method of claim 1 wherein the wavelength shift comprises primarily a laserdiode temperature change.

7. The method of claim 1 wherein the wavelength shift comprises primarily a WDM channel change.

8. The method of claim 1 wherein the first and second regions are selected to have different temperature dependence relative to wavelength, the method further comprising:
using the comparison to distinguish between 1) a wavelength drift of a source of the communications signal and b) a change in ambient temperature of the waveguide.

9. An optical component comprising:
an optical waveguide in which a first refractive index grating and a second refractive index grating is formed;
a first detector whose main incident light surface is at an angle of 45 degrees to 135 degrees relative to a longitudinal axis of the waveguide as measured from a point downstream of the surface, and positioned upstream of the first grating and outside of the waveguide; and
a second detector whose main incident light surface is at an angle of 45 degrees to 135 degrees relative to a longitudinal axis of the waveguide as measured from a point downstream of the surface, and positioned upstream of the second grating and outside of the waveguide, and
wherein the surfaces of the first and second detectors and the first and second gratings are oriented relative to each other about the longitudinal axis, so that out-coupled light from the first and second gratings is detected by the surfaces of the first and second detectors, respectively.

10. The optical component of claim 9 further comprising:
a first volume of index matching material that fills essentially the entirety of a light path for out-coupled light from the first grating, from an outside surface of the waveguide to the surface of the first detector.

11. The optical component of claim 10 further comprising:
a second volume of index matching material that fills essentially the entirety of a light path for out-coupled light from the second grating, from an outside surface of the waveguide to the surface of the second detector.

12. The optical component of claim 11 wherein the first and second volumes are of the same index matching material.

13. The optical component of claim 9 wherein in a detection wavelength band, a tap signal from the first detector increases in amplitude as a function of source wavelength and a tap signal from the second detector decreases in amplitude as a function of source wavelength.

14. The optical component of claim 13 wherein in the detection wavelength band, the tap signals intersect at a calibration wavelength of the optical component.

15. The optical component of claim 9 wherein the first and second gratings are rotated between 0 degrees and 180 degrees, about the longitudinal axis, relative to each other such that out-coupled light spots from the respective first and second gratings are essentially non-overlapping on their respective detector surfaces.

16. The optical component of claim 9 wherein transmission spectrum of the first grating is wavelength shifted relative to that of the second grating, in a detection wavelength band.

17. The optical component of claim 9 wherein transmission spectrum of the first grating is quasi flat and that of the second grating is wavelength dependent, in a detection wavelength band.

18. A system comprising:
a data processing subsystem to process data traffic forwarded by the device; and
an interface to an optical waveguide, the data processing system to process data traffic forwarded by the system over the waveguide, and wherein
the interface has an optical transmitter, first and second refractive index gratings formed in the waveguide, a first detector whose main incident light surface is positioned upstream of the first grating, a second detector whose main incident light surface is positioned upstream of the second grating,
wherein the surfaces of the first and second detectors' and the first and second gratings are oriented relative to each other about a longitudinal axis of the waveguide so that out-coupled light from the first grating and out-coupled light from the second grating are essentially non-overlapping on the respective surfaces of the first and second detectors, and
wherein signals from the first and second detectors are coupled to control the optical transmitter.

19. The system of claim 18 wherein each of the surfaces of the first and second detectors is at an angle of 45 degrees to 135 degrees relative to the longitudinal axis of the waveguide as measured from a point downstream of the surface.

20. The system of claim 19 further comprising:
a first volume of index matching material that fills essentially the entirety of a light path for out-coupled light from the first grating, from an outside surface of the waveguide to the surface of the first detector.

21. The system of claim 20 further comprising:
a second volume of index matching material that fills essentially the entirety of a light path for out-coupled light from the second grating, from an outside surface of the waveguide to the surface of the second detector.

22. The system of claim 21 wherein the first and second volumes are of the same index matching material.
